(19) United States
(12) Patent Application Publication
(10) Pub. No.: US 2007/0016637 A1
(43) Pub. Date: Jan. 18, 2007

(54) Bitmap network masks

(76) Inventors: John M. Brawn, San Jose, CA (US); Brian L. Jemes, Moscow, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/184,696

(22) Filed: Jul. 18, 2005

(51) Int. Cl. G06F 15/16

(52) U.S. Cl. 709/200

(57) ABSTRACT

A bitmap network mask is described for use in network functions such as data packet forwarding, access control list processing, and policy application determination. The bitmap network mask can be applied to a random collection of network parameters if desired. In one format, the bitmap network mask includes a mask sequence of entries in which each entry corresponds to a network parameter covered by the bitmap network mask and one or more indexing parameters for locating an entry in the mask sequence.

### BACKGROUND

### Field of the Invention

This invention generally relates to network masks, an example of which is a network address mask.

The basic purpose of a network mask is to easily determine whether a target parameter, for example a target network address, is subject to particular processing, for example the application of a security policy. In networking and computers in general which represent data in a binary format, masks are limited for efficiency to contiguously grouped parameters that are well positioned on even bit boundaries. These masking techniques are very inefficient if the list of parameters to be described is a more random collection, for example a nonsequential list of network addresses. In the case of network address masks, three levels of network masks exist today. The first is a bit length mask denoted by an integer following an address with usually a slash between them. This integer indicates the number of bits at the beginning of the address which are significant when comparing a test address to the address/mask object. As an example, “16.3.15.58/30” is a 32 bit address with 30 significant bits, and will match exactly 4 addresses: 16.3.15.56, 16.3.15.57, 16.3.15.58 and 16.3.15.59. Another network address mask is a contiguous mask which is usually written in the form of an address and a mask in the same format as the address. The mask includes binary ones for the bits that are significant and zeros for those that are not. (In some vendor implementations, the meaning of ones and zeros is reversed.) The same address range as above would be noted as “16.3.15.58 255.255.255.252”. In each octet, only 255, 254, 252, 248, 240, 224, 192, 128 and 0 are allowed. Another network address mask is a discontiguous mask which uses the same format as contiguous masks, but has 2 or more noncontiguous groupings of binary ones in the mask. Any mask with any octet with a value other than the 9 “allowed” values listed above is discontiguous. Any mask with more than one octet with a value other than 255 or 0 is discontiguous. Any mask with two octets of 255 separated by an octet of a different value is discontiguous. These masks allow you to define a regularly repeating set of address ranges. An example would be 16.3.15.58 255.255.254.252. This matches 2 sets of 4 addresses, 16.3.14.56 through 16.3.14.59 and 16.3.15.56 through 16.3.15.59. However, there are many real-world network situations where random collections of network addresses must be described. For example, none of these mask types can exactly match the following three addresses: 16.3.15.58, 16.3.15.61 and 16.3.15.62. To match these three addresses with existing mask types, you would need three masks. For example, three bit length masks would be needed as follows: 16.3.15.58/32, 16.3.15.61/32, and 16.3.15.62/32.

A network masking scheme that can efficiently describe a collection of network parameters, in particular a random collection of network parameters, and which can be applied to many common network functions such as applying network access control lists (ACL), and network packet forwarding is highly desirable.

### SUMMARY

The present invention provides one or more embodiments of solutions for processing network parameters using a bitmap network mask. In one embodiment, the bitmap network mask applies to a random collection of network parameters. One or more network functions can be performed based on the determination of whether the bitmap network mask applies to a network parameter or not. Additionally, one or more network functions can be performed based on information stored in an entry in a bitmap network mask. Some examples of network functions are data packet forwarding, access control list processing, and policy application determination.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1A is an example of a bitmap network mask in accordance with an embodiment of the present invention.

FIG. 1B is another example of a bitmap network mask in accordance with an embodiment of the present invention.

FIG. 2 is a functional block diagram of a computer-implemented system for processing network parameters in accordance with a bitmap network mask in accordance with an embodiment of the present invention.

FIG. 3 is a flow chart diagram of a computer-implemented method for processing network parameters in accordance with a bitmap network mask in accordance with an embodiment of the present invention.

FIG. 4A is a flow chart diagram of a method for determining whether a bitmap network mask applies to a network parameter in accordance with an embodiment of the present invention.

FIG. 4B is a flow chart diagram of a method for determining whether a bitmap network mask applies to a network parameter using an example format for a bitmap network mask in accordance with an embodiment of the present invention.

FIG. 5A illustrates another example of a bitmap network mask in accordance with another embodiment of the present invention.

FIG. 5B illustrates another example of a bitmap network mask in accordance with another embodiment of the present invention.

FIG. 5C illustrates another example of a bitmap network mask in accordance with another embodiment of the present invention.

FIG. 5D illustrates another example of a bitmap network mask in accordance with another embodiment of the present invention.

FIG. 6 is a flow chart diagram of a method for determining whether a bitmap network mask applies to a network parameter in accordance with another embodiment of the present invention.

FIG. 7 is a flow chart diagram of a method for creating a bitmap network mask in accordance with an embodiment of the present invention.

FIG. 8 is a flow chart diagram of a method for updating a bitmap network mask in accordance with an embodiment of the present invention.

FIG. 9 is a flow chart diagram of a method for updating a bitmap network mask in accordance with another embodiment of the present invention.

FIG. 10 is an architectural diagram of an example context in which a system or a method for processing network parameters in accordance with a bitmap network mask can operate in accordance with one or more embodiments of the present invention.

FIG. 11 is a flow chart diagram of a method for creating a forwarding table using one or more bitmap network masks in accordance with an embodiment of the present invention.

FIG. 12 is a flow chart diagram of a method for making a forwarding decision for a data packet using a bitmap network mask in accordance with an embodiment of the present invention.

FIG. 13 is a flow chart diagram of a method for performing proxy address resolution using a bitmap network mask responsive to a request received from a directly connected address in accordance with an embodiment of the present invention.

FIG. 14 is an example of a bitmap network mask including more than one bit per entry in accordance with another embodiment of the present invention.

FIG. 15 is a flow chart diagram of a method for locating an entry within a bitmap network mask with multiple bits per entry for a network parameter in accordance with another embodiment of the present invention.

The figures depict embodiments of the present invention for purposes of illustration only. One skilled in the art will readily recognize from the following discussion that other embodiments of the structures and methods illustrated herein may be employed without departing from the principles of the invention described herein.

### DETAILED DESCRIPTION

In one embodiment, a bitmap network mask comprises a mask sequence of bits wherein each bit is an entry corresponding to at least one network parameter, and one or more indexing parameters for use in locating the corresponding bit for a target parameter. An example of a network parameter is a network address. Some examples of network addresses are the various versions (e.g., version 4 or version 6) of Internet Protocol (IP) addresses. Another example of a network parameter is a network communication protocol (e.g., Transport Control Protocol (TCP), User Datagram Protocol (UDP)), and yet another example of a network parameter is a port (e.g., port 80). A bitmap network mask can be applied to a random collection of network parameters. For example, one bitmap network mask can apply to 16.3.15.58, 16.3.15.61, and 16.3.15.62 despite these addresses being noncontiguous.

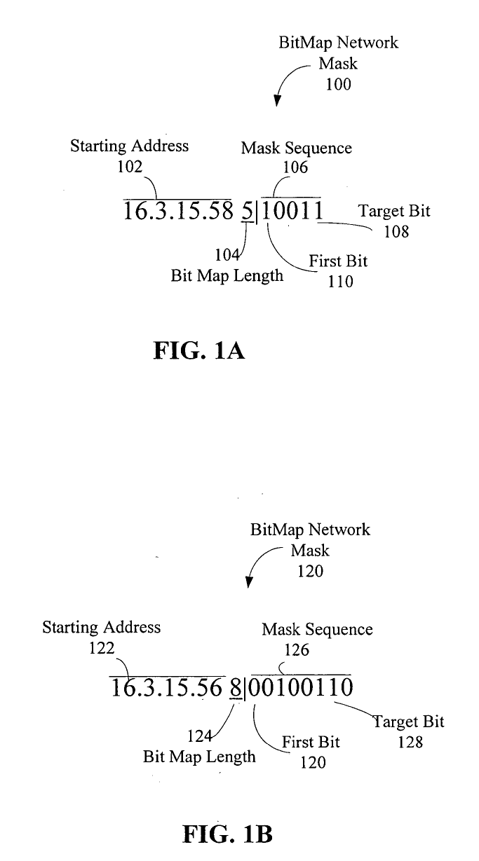

FIG. 1A is an example of a bitmap network mask 100 in accordance with an embodiment of the present invention. In this example, the network parameter is an Internet Protocol address. The mask 100 comprises a starting address 102 of 16.3.15.58, a bitmap length 104 of 5 and a mask sequence 106 of entries with an entry size of one bit. The starting parameter, in this case, starting address 102 is an indexing parameter used in conjunction with another indexing parameter, the bitmap length 104 which in this example of one bit entries maps directly to the number of parameters covered in the range of the mask sequence 106, to locate a bit in the mask sequence 106 corresponding to a target address, hereafter referred to as the target bit. For example, a data packet from IP address 16.3.15.62 is received. In order to determine if an ACL allows data from this address, it is determined whether the bitmap mask 100 applies. In this example, the starting address 102 16.3.15.58 is subtracted from the target address 16.3.15.62 resulting in a difference of four (4). The bitmap length 104 of five (5) indicates that there are five (5) network addresses, 16.3.15.58, 16.3.15.59, 16.3.15.60, 16.3.15.61, and 16.3.15.62, in the range of this bitmap mask 100. The first bit 110 of the mask sequence 106 corresponds to the starting address 102 of 16.3.15.58, and each subsequent bit in the sequence corresponds to each subsequent address in the range. The difference of four indicates that the target address is in the range of the bitmap mask 100, and this difference is used to index the target bit 108 in the mask sequence 106. The first bit is treated as bit number 0, so bit number 4, the fifth bit in the sequence is the target bit 108. In this example, a “1” value indicates that the bitmap applies, and a “0” indicates that it does not apply. The target bit 108 is a “1” so data from this address is allowed access. This bitmap network mask 100 also applies to 16.3.15.58 and 16.3.15.61 as indicated by bit 0 and bit 3 of the mask sequence also having values of one.

FIG. 1B is another example of a bitmap network mask 120 in accordance with an embodiment of the present invention that also applies to addresses 16.3.15.58, 16.3.15.61 and 16.3.15.62. In this example, the bitmap network mask 120 has a starting address 122 of 16.3.15.56 and an ending address of 16.3.15.63 as indicated by the bit map length 124 of eight (8) one bit entries. In this example, the bitmap network mask 120 does not apply to starting address 122 as indicated by the first bit 120 being a zero. By subtracting the starting address 122 from our target address of 16.3.15.62 as in the example above, the difference is six (6) corresponding to the seventh bit as the target bit 128 which has a value of one indicating the bitmap network mask 120 applies.

By manipulating a starting parameter (e.g., 102, 122) and the bit map length (e.g., 104, 124), a bitmap network mask (e.g., 100 or 120) can cover any range of network parameter. In practice, a bitmap network mask can be designed to cover a constant range of network parameters so that the size and indexing parameter(s) remain the same. For example, a bitmap network mask of bit map length 2³² can be used to cover all IPv4 addresses 0.0.0.0 to 255.255.255.255. In one example, such a bitmap can be used to block network packets from addresses that send spam. The size of the bitmap alone (does not including memory for the indexing parameters or other fields) would take up approximately 512 Megabytes which is within the memory range of currently available routers. The bitmap can also be made smaller by not including reserved areas of Internet addresses (e.g., those whose first byte is a zero or a ten or 248 and above up to 255). Similarly, a number of smaller bitmaps can be used for the different class sized networks, e.g., class A at about 2048 Kbytes, class B at about 8192 bytes, class C at about 32 bytes. In another example, a bitmap of about 256 Kbytes can be used for all/29 subnets in a class A sized network. In another example, a bitmap network mask can cover all TCP/UDP ports with a bitmap network mask of about 8192 bytes. In another example, all TCP/UDP ports less than 1024 can be covered with a bitmap network mask of about 128 bytes. In another example, a bitmap of 32 bytes can be used to cover all IP protocols. In these examples, the sizes of the bitmap masks are based on a bitmap network mask of one bit entries.

A bitmap network mask allows for one mask to be applied to a random collection of network parameters. For example, as stated above, a single bitmap network mask can apply to all IPv4 addresses. Furthermore, the throughput for checking or updating an entry associated with a parameter in the bitmap mask is practically the same for any parameter. For example, the processing of indexing into the bitmap mask sequence covering all IPv4 addresses and checking the value of a target entry for a target address is practically the same for each address. Any very small difference is in the time difference between finding the difference between two large numbers as opposed to the time difference for finding the difference between a large one and a very small one.

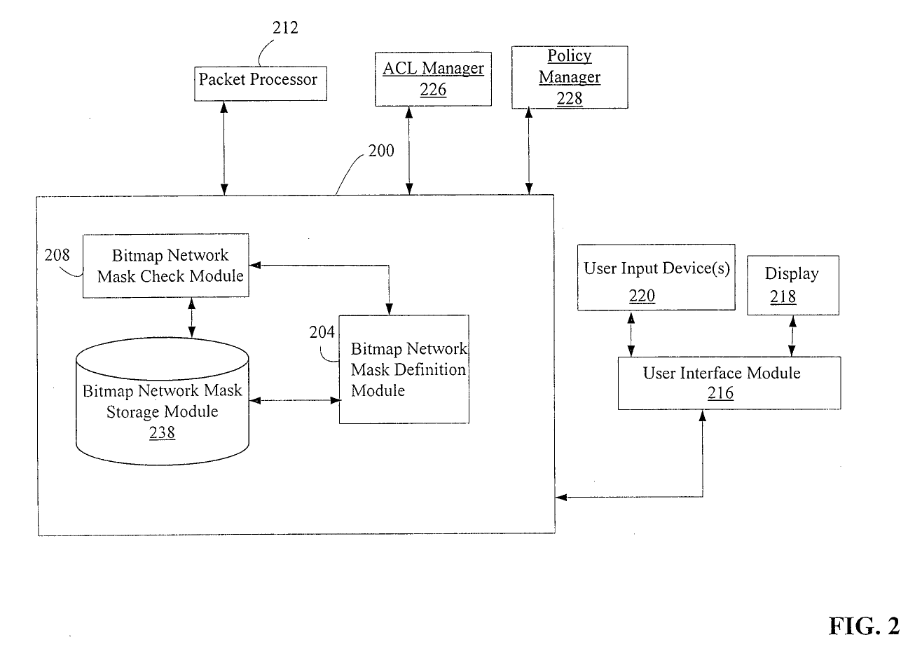

FIG. 2 is a functional block diagram of a computer-implemented system 200 for processing network parameters in accordance with a bitmap network mask in accordance with an embodiment of the present invention. Some examples of devices in which the system 200 can operate are a router, a switch or a server. The system 200 comprises a bitmap network address mask storage module 238, a bitmap network mask definition module 204 having access to the bitmap network address mask storage module 238, and a bitmap network mask check module 208 also having access to the bitmap network address mask storage module 238 and being communicatively coupled to the bitmap network mask definition module 204.

The bitmap network mask definition module 204 is communicatively coupled to the user interface module 216 for receiving user input entered via one or more user input device(s) 220 for defining a bitmap network mask. Some examples of user input for defining a bitmap network mask include the network parameters to which the mask is to be applied. The bitmap definition module 204 can determine one or more indexing parameters based on the applicable network parameters or it can determine the indexing parameters from values provided in user input. As illustrated in the examples of FIGS. 1A and 1B, a bitmap length and a starting parameter such as an address can be used as indexing parameters into the mask sequence. The bitmap network mask definition module 204 determines a number of entries for the bitmap, determines the settings of the entries for indicating to which network parameters the mask applies and/or additional information about the parameters based on network parameters received via user input and the indexing parameters, and sets the entries accordingly. The bitmap network mask definition module 204 can also modify a bitmap mask. For example, if parameters not within the range of covered parameters are desired to be added, the definition module 204 can modify the bitmap network mask to accommodate them. Furthermore, the definition module 204 can update the corresponding entry of a parameter in the bitmap mask to reflect a change in status of that parameter. In one example, responsive to receiving a request for defining a bitmap mask, the bitmap network mask definition module 204 generates a user interface display (not shown) of a webpage having text boxes, drop down menus and selectable display areas (e.g., buttons) prompting a user for the set of parameters to which the bitmap network mask is to be applied. Additionally, the user can be prompted for one or more indexing parameters. The user interface module 216 causes the display 218 to present the webpage and forwards received user input to the bitmap network mask definition module 204. Responsive to a request to update an existing bitmap network mask, the bitmap network mask definition module 204 generates a user interface display, for example a web page including text boxes, drop down menus and selectable display areas (e.g., buttons), prompting a user to identify an existing bitmap mask, for example by selecting an identifier from a drop down menu for bitmaps, and for the set of parameters to be updated in the bitmap mask. The set of parameters can be one or more indexing parameters or one or more network parameters to be updated or both. A newly created bitmap network mask or an update to a bitmap network mask is stored by the bitmap network mask definition module 204 in the accessible bitmap network mask storage module 238. The definition module 204 can send a notification message to the communicatively coupled bitmap network mask check module 208 that a new bitmap mask has been created or one has been modified so it can make sure it is using the most current bitmap mask.

The bitmap network mask check module 208 determines whether a bitmap network mask applies to a target network parameter, and sends an indicator (e.g., a message) of applicability to a requesting module. In the illustrated embodiment, some examples of network management tools which can advantageously use bitmap network masks in their processing are communicatively coupled to the bitmap network mask check module 208 in the system 200. These examples include a packet processor 212, an ACL Manager 226, and a policy manager 228, each of which can send a target parameter to the bitmap network mask check module 208 for an applicability determination against one or more bitmap network masks stored in the bitmap network mask storage module 238. For example, the network address associated with an incoming packet that the packet processor 212 has received from a network interface is tested to determine if it is to be sent down a forwarding path for addresses to which the bitmap mask applies. Additionally, a bitmap network mask with multiple entries can provide other information for network functions such as age information.

Each of the modules illustrated in FIG. 2 or a portion thereof can be implemented in software suitable for execution on a processor and storage in a computer-usable medium, hardware, firmware or any combination of these. Computer-usable media include any configuration or medium capable of storing or transferring programming, data, or other digital information. Examples of computer-usable media include a data transmission as well as various memory embodiments such as random access memory and read only memory, which can take a variety of forms, some examples of which are a hard disk, a disk, flash memory, or a memory stick. Additionally, any of the modules or a portion thereof can operate on different processors and communicate with each other for performing their functions or be stored in memory accessible over a network by the other modules.

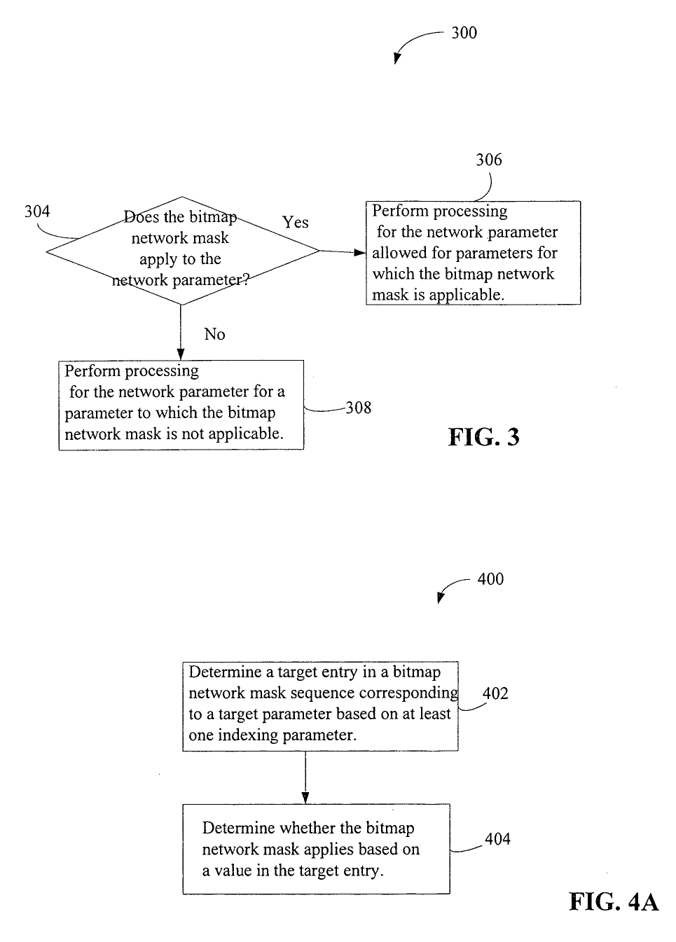

FIG. 3 is a flow chart diagram of a computer-implemented method 300 for processing network parameters in accordance with a bitmap network mask in accordance with an embodiment of the present invention. For illustrative purposes only and not to be limiting thereof, the method embodiment 300 of FIG. 3 is discussed in the context of the system embodiment 200 of FIG. 2. The bitmap network mask check module 208 determines 304 whether a bitmap network mask applies to a network parameter. Responsive to the bitmap network mask applying to the network parameter, the requesting module such as the packet processor 212, the ACL Manager 226 or the policy manager 228 performs 306 processing for the network parameter allowed for parameters for which the bitmap network mask is applicable. Responsive to the bitmap network mask not applying to the network parameter, the requesting module (e.g., 212, 226, 228) performs 308 processing for the network parameter for a parameter to which the bitmap network mask is not applicable.

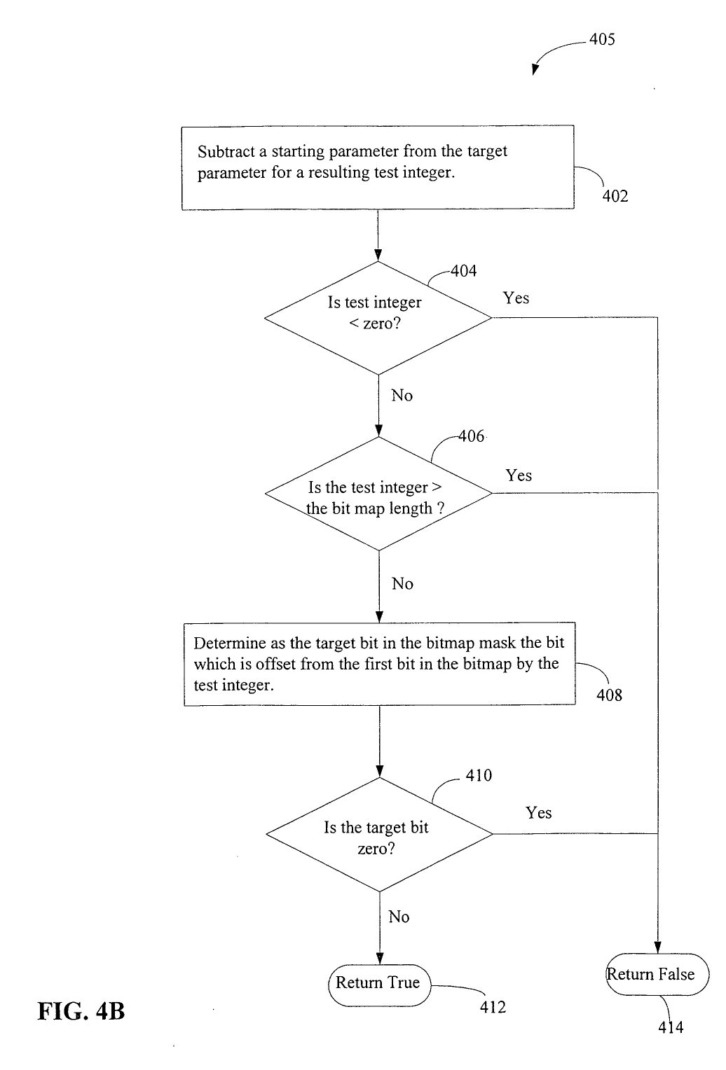

FIG. 4A is a flow chart diagram of a method for determining whether a bitmap network mask applies to a network parameter in accordance with an embodiment of the present invention. For illustrative purposes only and not to be limiting thereof, the method embodiment 400 of FIG. 4A is discussed in the context of the system embodiment 200 of FIG. 2. The bitmap network mask check module 208 determines 402 a target entry in a bitmap network mask sequence corresponding to a target parameter based on at least one indexing parameter, and determines 404 whether the bitmap network mask applies based on a value in the target entry.

FIG. 4B is a flow chart diagram of a method for determining whether a bitmap network mask applies to a network parameter for one or more embodiments of the present invention using an example of a bitmap network mask format including a starting parameter and a bitmap length as indexing parameters. For illustrative purposes only and not to be limiting thereof, the method embodiment 405 of FIG. 4B is discussed in the context of the system embodiment 200 of FIG. 2. Additionally, one bit entries for the mask sequence is assumed for this example. The bitmap network mask check module 208 subtracts 402 a starting parameter from a target parameter for a resulting test integer and determines 404 whether the test integer is less than zero. The target parameter is the parameter currently being checked against the bitmap network mask. Responsive to the test integer being less than zero, the check module 208 returns 414 false which is an example of an indicator that the mask does not apply. Responsive to the test integer not being less than zero, the check module 208 determines 406 whether the test integer is greater than the bitmap length. Responsive to the test integer being greater than the bitmap length, the check module 208 returns 414 false. Responsive to the test integer not being greater than the bitmap length, the check module 208 determines 408 as the target bit in the bitmap mask the bit which is offset from the first bit in the bitmap by the test integer, and determines whether 410 the target bit is zero. In this example, the target bit being zero means the mask does not apply. The reverse convention of the target bit being one for indication that the mask does not apply can also be used. Responsive to the target bit being zero, the bitmap network mask check module 208 returns 414 false, and responsive to the target bit not being zero, the bitmap network mask check module 208 returns 412 true which is an example of an indicator that the mask does apply.

The length of the bitmap, the number of network parameters that each entry references, and the number of times that a mask repeats can each be any integer. There is no requirement that any of these values be powers of two (2) or even numbers. This can give significant new flexibility to network addressing schemes which have until now usually been locked into powers of 2 on even boundaries.

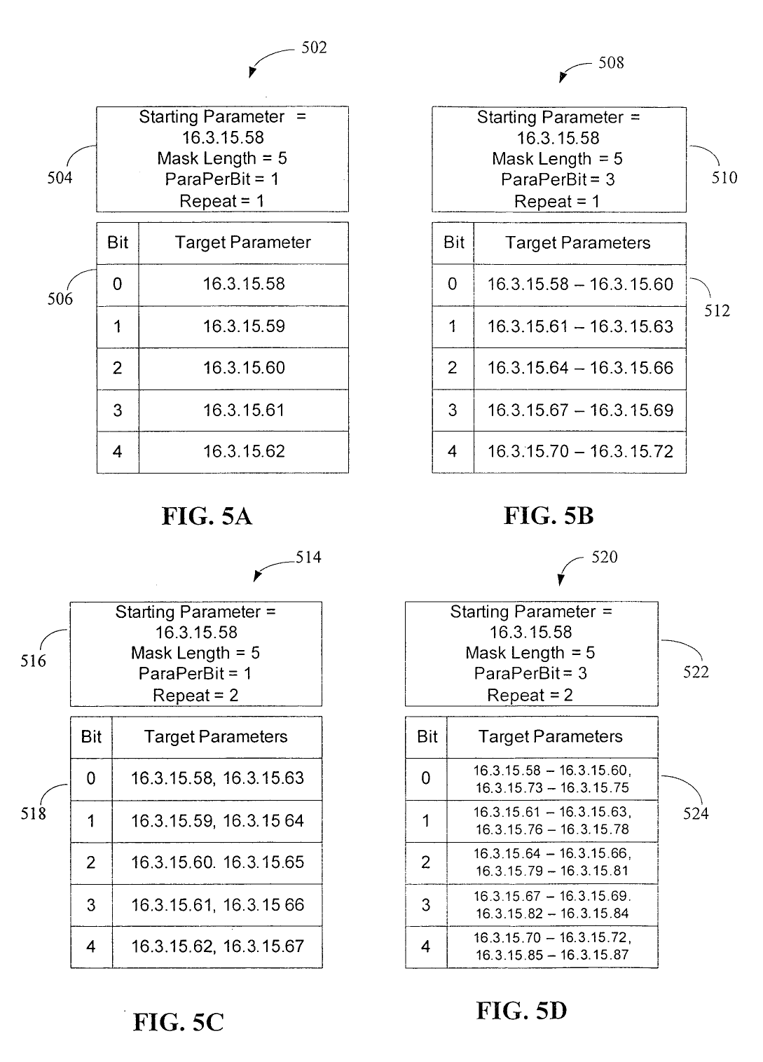

FIGS. 5A, 5B, 5C and 5D illustrate some other examples of bitmap network masks in accordance with other embodiments of the present invention. Each of these examples can be stored as a bitmap network mask entry in a table of bitmap network mask entries as can be stored for example in the bitmap network mask storage module 238. Additionally, these examples illustrate bitmap masks with one-bit entries. FIG. 5A illustrates a bitmap network mask 502 having a mask sequence 506 and having as indexing parameters 504 a starting parameter, which in this example is an address, a mask length, a number of parameters per bit denoted as a field labeled “ParaPerBit,” and a number of times the mask is repeated as indicated by a “Repeat” field. As the values of ParaPerBit and Repeat are one (1), the mask sequence 506 has one bit corresponding to each parameter in the range of five (5) parameters covered by the bitmap network mask 502 starting with the starting parameter, address 16.3.15.58. The number of parameters per bit and the number of times the mask repeats can be set to extend a bitmap to more parameters than its bitmap length when groups of parameters are subject to the same processing. For example, the number of parameters per bit field allows the bitmap network mask to be used to denote subnets, networks or supernets as well as individual addresses. This is very useful in assigning policies to subnets within a network on a subnet by subnet basis. The number of times the mask repeats field can be used to allow the same bitmapped policy to be implemented in multiple adjacent address ranges. For example, a network with five adjacent class B networks could use a mask that covers one class B network, and repeat it five times to implement the same policy on each of the class B nets.

FIG. 5B illustrates a bitmap network mask entry 508 including indexing parameters 510 of a starting parameter of address 16.3.15.58, a mask length of five (5), a ParaPerBit of three (3), and a Repeat of one (1). Because the number of parameters per bit, in this case addresses, is three (3), this bitmap network mask 508 covers fifteen (15) parameters with a mask sequence 512 of only five (5) bits.

FIG. 5C illustrates a bitmap network mask entry 514 including indexing parameters 516 of a starting parameter of address 16.3.15.58, a mask length of five (5), a ParaPerBit of one (1), and a Repeat of two (2). Because of the Repeat of two (2), this bitmap network mask 514 covers ten (10) parameters with a mask sequence 518 of only five (5) bits.

FIG. 5D illustrates a bitmap network mask entry 520 including indexing parameters 522 of a starting parameter of address 16.3.15.58, a mask length of five (5), a ParaPerBit of three (3), and a Repeat of two (2). Because of the number of addresses being three (3) and the map repeating twice, this bitmap network mask 520 covers thirty (30) addresses with a mask sequence 524 of only five (5) bits.

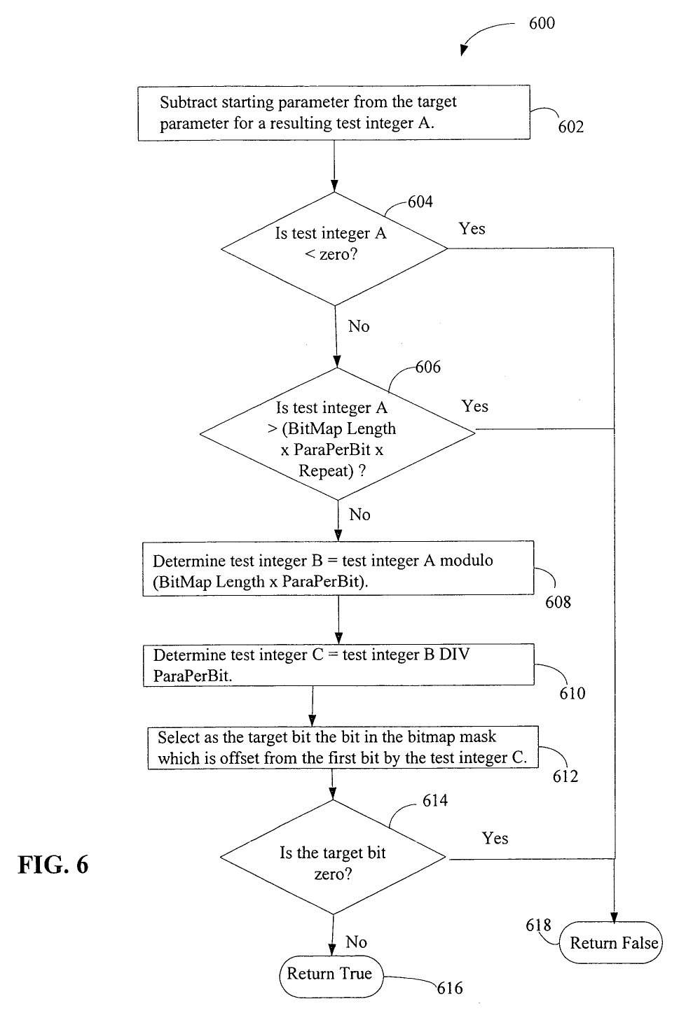

FIG. 6 is a flow chart diagram of a method 600 for determining whether a bitmap network mask of one bit entries applies to a network parameter in accordance with one or more embodiments of the present invention using a bitmap network mask format including the indexing parameters of a starting parameter, a mask length, a number of parameters per bit and a number of times the mask repeats. For illustrative purposes only and not to be limiting thereof, the method embodiment 600 of FIG. 6 is discussed in the context of the system embodiment 200 of FIG. 2. The bitmap network mask check module 208 subtracts 602 a starting parameter of the mask from the target parameter for a resulting test integer A and determines 604 whether the test integer A is less than zero. Responsive to the test integer A being less than zero, the check module 208 returns 618 false. Responsive to the test integer A not being less than zero, the check module 208 determines 606 whether the test integer A is greater than the product of the BitMap Length multiplied by the number of parameters per bit, ParaPerBit, multiplied by the number of times the mask is repeated, Repeat. Responsive to the test integer A being greater than the product, the check module 208 returns 618 false. Responsive to the test integer A not being greater than the product, the check module 208 determines 608 test integer B as the result from test integer A modulo the product of the BitMap Length multiplied by the number of parameters per bit, ParaPerBit. Additionally, the check module 208 determines 610 test integer C as the quotient of test integer B divided by the number of parameters per bit, ParaPerBit, and selects 612 as the target bit the bit in the bitmap mask which is offset from the first bit by the test integer C. The check module 208 determines 614 whether the target bit is zero, which in this example is indicative that the bitmap network mask does not apply. Responsive to the target bit being zero, the check module 208 returns 618 false, and responsive to the target bit not being zero, the check module 208 returns 616 true as an indicator that the bitmap network mask applies to the network parameter.

Some examples of other indexing parameters that can be associated with a bitmap network mask are a version field which allows a single table to contain bitmap network mask entries that represent different implementations which are not fully backward compatible with the initial description, and a type field which allows a single table to contain bitmap network mask entries that represent different types of objects such as addresses, port ranges, protocol types, etc. For example, if a type field is an 8 bit field, different values can designate different network parameters as indicated in the following examples: “00000001” is used for IP address entries for IPv4, “00000010” is used for TCP and/or UDP port masks, “00000100” is used for IP protocol masks,” and “00001001” is used for bitmap forwarding. Another example is a bitmap mask identifier. In one example, the three fields of version, type and bitmap mask identifier can be used to uniquely identify a bitmap mask entry. Another example is a revision field which can be incremented each time the bitmap is changed.

FIG. 7 is a flow chart diagram of a method 700 for creating a bitmap network mask in accordance with an embodiment of the present invention. For illustrative purposes only and not to be limiting thereof, the method embodiment 700 of FIG. 7 is discussed in the context of the system embodiment 200 of FIG. 2. The bitmap mask definition module 204 receives 702 one or more network parameters for which a bitmap network mask will apply, and determines 704 one or more indexing parameters for the bitmap network mask. The one or more indexing parameters can be indicated directly in user input or the definition module 204 can use default parameters, for example a default starting address for a class A network if the parameter were an address. In one example, the definition module can also use as a starting parameter a parameter in the received network parameters that comes first if the parameters were ordered sequentially and determine a bitmap length based on the number of received network parameters. Different methods for indexing into the bitmap can be used, some examples of which were described in FIGS. 4B and 6. Additionally, a starting parameter could be a number at the end of an ordered list of the parameters from which a target parameter is subtracted. The bitmap mask definition module 204 determines 706 the number of entries for the bitmap mask sequence based on the one or more indexing parameters and the received network parameters. For example, the definition module 204 can determine a number of bits for a mask sequence of one bit entries that is at least as long as the bitmap length. The bitmap mask definition module 204 sets 708 the entries in the mask sequence to indicate to which network parameters the bitmap network mask applies.

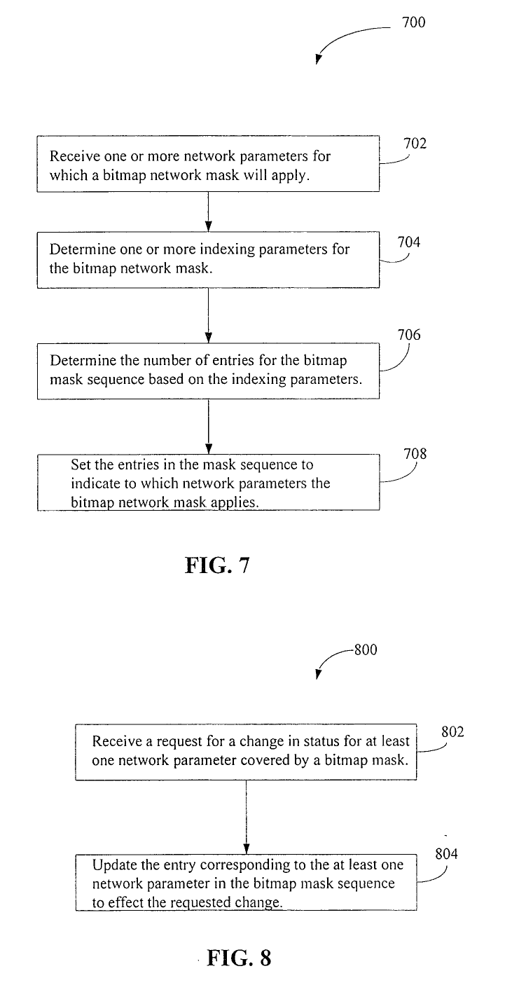

FIG. 8 is a flow chart diagram of a method for updating a bitmap network mask in accordance with an embodiment of the present invention. For illustrative purposes only and not to be limiting thereof, the method embodiment 800 of FIG. 8 is discussed in the context of the system embodiment 200 of FIG. 2. The bitmap mask definition module 204 receives 802 a request for a change in status for at least one network parameter covered by a bitmap mask, and updates 804 the entry corresponding to the at least one network parameter in the bitmap mask sequence to effect the requested change.

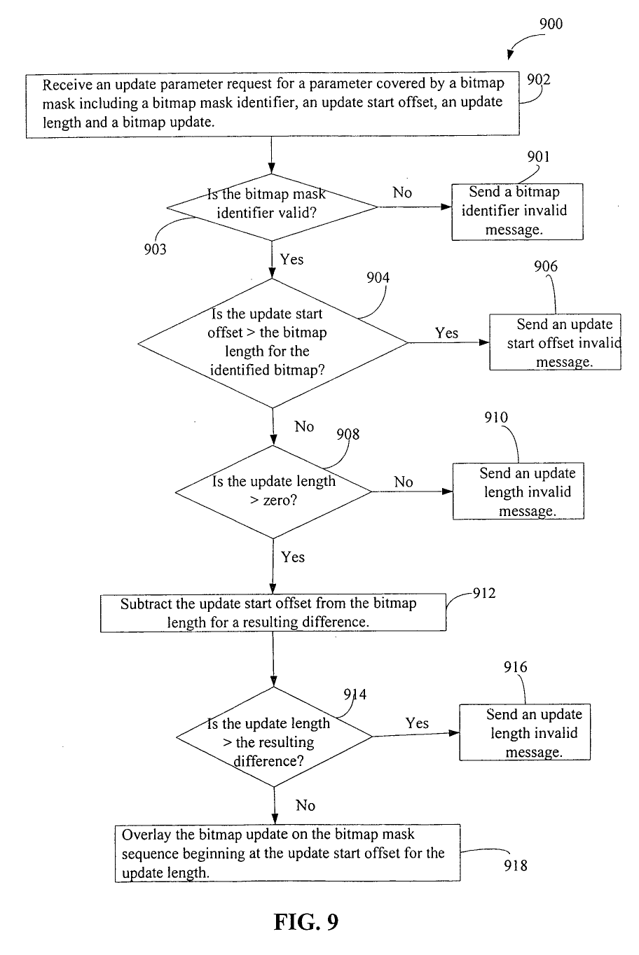

FIG. 9 is a flow chart diagram of a method for updating a bitmap network mask by overlaying a bitmap update to at least a portion of the bitmap network mask sequence in accordance with another embodiment of the present invention. For illustrative purposes only and not to be limiting thereof, the method embodiment 900 of FIG. 9 is discussed in the context of the system embodiment 200 of FIG. 2. In one example for this embodiment, the bitmap length can be the number of bits in the sequence for a mask in which each bit corresponds to a parameter. In another example for this embodiment, the bitmap length can also be the number of bits equal to the number of parameters in the range of the mask sequence multiplied by the entry size. The bitmap mask definition module 204 receives 902 an update parameter request for a parameter covered by a bitmap mask including a bitmap mask identifier, an update start offset, an update length and a bitmap update and determines 903 whether the bitmap mask identifier is valid. Responsive to the identifier being invalid, the definition module 204 sends 901 a bitmap identifier invalid message. Responsive to the identifier being valid, the bitmap mask definition module 204 determines 904 whether the update start offset is greater than the bitmap length for the identified bitmap. Responsive to the update start offset being greater than the bitmap length for the identified bitmap, the bitmap mask definition module 204 sends 906 an update start offset invalid message. Responsive to the update start offset being greater than the bitmap length for the identified bitmap, the definition module 204 determines whether the update length is greater than zero, and sends 910 an update length invalid message responsive to the update length not being greater than zero. Responsive to the update length being greater than zero, the definition module 204 subtracts 912 the update start offset from the bitmap length for a resulting difference and determines 914 whether the update length is greater than the resulting difference. Responsive to the update length being greater than the resulting difference, the bitmap mask definition module 204 sends 916 an update length invalid message. Responsive to the update length not being greater than the resulting difference, the bitmap mask definition module 204 overlays 918 the bitmap update on the bitmap mask sequence beginning at the update start offset for the update length.

The settings of bits in the bitmap update can be interpreted in a variety of ways. For illustrating some examples of interpretations of a bitmap update, the update parameter request further includes an update operation field for indicating how the bits of the bitmap update are to be interpreted. For example, the update operation can indicate a replace operation in which all bits in the bitmap starting at the update start offset and continuing for the update length are replaced by the bits in the bitmap update. In another example, a return value operation can be requested by the update operation field to check the current values of the bitmap. Some examples of update operations particularly useful for a bitmap mask of one bit entries are as follows: the update operation can indicate an OR operation in which for every binary one in the bitmap update, the corresponding bit in the bitmap is changed to one; the update operation can indicate a Not OR operation in which for every binary one in the bitmap update, the corresponding bit in the bitmap is changed to zero; and another operation which can be indicated is a toggle or XOR operation in which for every binary one in the bitmap update, the corresponding bit in the bitmap is changed, either from zero to one, or from one to zero.

At times, a setting corresponding to a single parameter is updated or has its value checked. For illustrating some examples of changing or reading an entry for a single parameter, the update parameter request further includes a single parameter field for indicating the target parameter, for example, an IP address. Update operation can be used to indicate operations on a single parameter, for example, a range of values indicates a range of operations for a single parameter, and another range of values indicates another range of operations for a bitmap update. In one example, the update operation indicates a return value operation on the single parameter. For example, an IP address is checked to see if it is covered by a bitmap for blacklisted addresses before proceeding with checking the address against other bitmaps for forwarding in the network. In another example, the update operation indicates that there is no update on the single parameter. Other examples of operations for a target entry of one bit corresponding to the single target parameter are setting the target bit to an on state, setting the target bit to an off state, and toggling the value of the target bit.

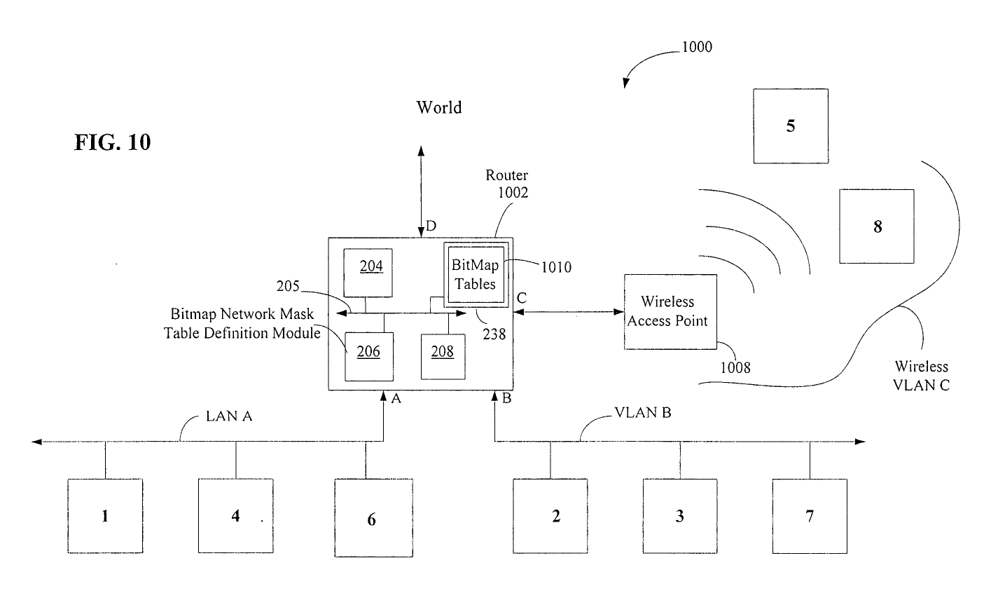

FIG. 10 is an architectural diagram of an example context 1000 in which a system or a method for processing network parameters in accordance with a bitmap network mask can operate in accordance with one or more embodiments of the present invention. This example context comprises a router 1002, a local area network LAN A and two virtual local area networks VLAN B and VLAN C including computers each having an IP address of which eight examples, computers 1, 2, 3, 4, 5, 6, 7 and 8, are illustrated. LAN A comprises computers including the illustrated examples of computers 1, 4, 6 that have a wired connection to the router 1002. VLAN B comprises computers including the illustrated examples of computers 2, 3, 7 that have a wired connection to the router 1002. VLAN C comprises computers including the illustrated examples of 5 and 8 which have a wireless connection to a wireless access point 1008 which has a wired connection to the router 1002. In this example, a router 1002 of an intermediate node is chosen for illustrative purposes. However, the discussion is also applicable to other networking devices, for example a switch.

In this example, the router 1002 comprises interfaces labeled A, B, C and D which can be virtual interfaces, physical interfaces, or a combination of both. Interface A connects with LAN A; interface B connects with VLAN B; interface C connects with VLAN C; and interface D connects with the public Internet to access other networks represented by “World.” The router 1002 also comprises modules which are communicatively coupled via a communication interface 205 (e.g., bus) including the bitmap network mask definition module 204, the bitmap network mask check module 208, the bitmap network mask storage module 238 including bitmap network mask tables 1010 stored in its memory, and a bitmap network mask table definition module 206 for generating network tables 1010 such as forwarding tables and ACLS including identifiers for the various bitmap network masks for linking them to interfaces, devices or other network parameters as appropriate for the type of table. In this example, the bitmap mask tables 1010 include tables of entries with bitmap mask identifiers, each bitmap mask covering a range of addresses for the computers in the LAN and VLANs for different types of network parameters or functions (e.g., IP addresses, TCP and/or UDP ports, and bitmap forwarding). The following operational examples illustrate uses for bitmap network masks in network management and operations environments.

In this example, computers 1 through 8 can also dynamically move around the VLANs and LAN. As each computer 1 to 8 is dynamically detected, the respective computer becomes active and is added to LAN A, VLAN B or VLAN C by changing the bitmapped entry which relates to the computer's IP address in a bitmap network mask linked to a bitmap table 1010 that defines membership on the particular LAN or VLAN. This same mask can be used for ACLs or firewall rules for access to and from each LAN or VLAN as well as for forwarding tables for level 3. These examples illustrate that a large number of ordinary masks (e.g. an ACL with dozens of entries) can be reduced to a single bitmap network mask, thus, greatly simplifying ACL administration and operation. For example, instead of having eight statements allowing TCP from any of the eight computers to the World written in Cisco IOS format such as the following:

| Allow\|Deny | Protocol | Port | Source | Destination |
|---|---|---|---|---|
| Allow | TCP | 21 | IPv4 of Computer 1 | 0.0.0.0/0.0.0.0 |
| Allow | TCP | 21 | IPv4 of Computer 2 | 0.0.0.0/0.0.0.0 |
| Allow | TCP | 21 | IPv4 of Computer 3 | 0.0.0.0/0.0.0.0 |
| Allow | TCP | 21 | IPv4 of Computer 4 | 0.0.0.0/0.0.0.0 |
| Allow | TCP | 21 | IPv4 of Computer 5 | 0.0.0.0/0.0.0.0 |
| Allow | TCP | 21 | IPv4 of Computer 6 | 0.0.0.0/0.0.0.0 |
| Allow | TCP | 21 | IPv4 of Computer 7 | 0.0.0.0/0.0.0.0 |
| Allow | TCP | 21 | IPv4 of Computer 8 | 0.0.0.0/0.0.0.0 |

the use of bitmap network masks allows replacement of not only these eight statements but any other statements regarding for which ports TCP is denied/allowed with just one statement:

| Allow\|Deny | Protocol | Port | Source | Destination |
|---|---|---|---|---|
| Allow | TCP | BitMap | BitMap | BitMap |
| | | Identifier | Identifier | Identifier |
| | | (Ports) | (Source) | (Destination) |

Instead of having to check the port against eight statements, the router 1002 only has to check the port against one statement including bitmap identifiers which the router 1002 via the bitmap network mask check module 208 uses to locate the applicable target parameters for the statement. The versatility of the bitmap network mask approach also makes unnecessary pre-allocating address space to LAN A or VLANs B and C. Addresses are allocated on a one by one basis as needed, providing previously unobtainable network agility. Also, no addresses are lost from the pool of available addresses because of subnet broadcast and deprecated broadcast address reservations. If subnets were added into LAN A or VLAN B or VLAN C to support multiple clients, then at least 2 addresses would be lost for each subnet used. With a bitmap network mask defining LAN or VLAN membership, multiple LANs/VLANs can share the same single subnet pool of addresses, thereby substantially reducing wasted IP addresses and alleviating the need to renumber existing networks which is very costly.

In one example, a bitmap network mask for a firewall policy associated with employees covers computers 1 to 8 although only those whose computers which are on LAN A are employees. Assuming one bit entries for this illustration, the bits in the bitmap for the LAN A computers 1, 4 and 6 are set to one in this example to indicate the policy applies to them while those for VLAN B and VLAN C computers are set to zero. VLAN B is used for network addresses of computers used by on-site contractors for whom a firewall policy is different than that associated with LAN A. If the person using computer 7 is hired on as an employee, the bit in the bitmap for the LAN A firewall policy associated with the network address of computer 7 is now set to one. No ACL list needs to be updated in this example, nor a new IP address be assigned to the computer of the newly hired employee.

Multiple firewall “rules” can be simultaneously updated to reflect the addition (or removal) of a client in a LAN or VLAN without having to add or remove individual rule statements or ACL statements. This is accomplished by being able to update a bitmap mask entry associated with an IP address to be added or removed. As illustrated, using a bitmap network mask also allows fine grained control over the policy enforced by the mask by allowing systematic access to change specific bits in the mask over time.

For example, enterprise and web service firewalls can implement a bitmap network mask for blacklisting individual IP addresses that have been detected to violate security policies, e.g., by attempting to infect systems with worms or viruses. The bitmap network mask definition module 204 in the router 1002 can populate and expire addresses in a bitmap network mask in one of the tables of 1010 identifying blacklisted addresses automatically by setting their bits accordingly. Enterprise firewalls today are usually unable to block access from a constantly changing and potentially large list of “bad” clients. However, with bitmap network masks, the load (and therefore throughput) on the enterprise firewall stays constant no matter how many individual IP addresses are added or removed from the blacklist mask.

In another example, proxies can implement client authentication for outbound access by using a bitmap network mask to allow access only from client computers that have successfully authenticated. Proxies and firewalls have difficulty maintaining state for large numbers of authenticated users, especially when that state must be shared between proxy or firewall devices. Often, special protocols are required such as Virtual Private Networks (VPNs) or socket encapsulation in order to identify authenticated users. ACLs are virtually never used because of the difficulty of managing hundreds of ACL entries where one or more is needed for each authenticated user. A bitmap network mask that defines IP addresses of authenticated users can be updated as each user authenticates and expires. The proxy or firewall can implement a static rule set against a dynamic bitmap network mask. This greatly reduces the complexity and effort involved in controlling this kind of dynamic access.

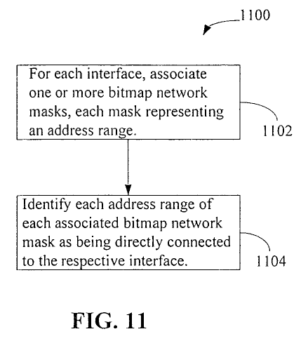

FIG. 11 is a flow chart diagram of a method 1100 for creating a forwarding table using one or more bitmap network masks in accordance with an embodiment of the present invention. For illustrative purposes only and not to be limiting thereof, the method embodiment 1100 of FIG. 11 is discussed in the context of the system embodiment 1000 of FIG. 10. The bitmap network mask table definition module 206 associates 1102 one or more bitmap network masks, each mask representing an address range, for each interface of the router 1002 (or of another networking device, e.g., a switch, in other examples), and identifies 1104 each address range of each associated bitmap network mask as being directly connected to the respective interface. In one example, the same bitmapped address range can be associated with a plurality of interfaces. This bitmapped address range can be represented by the same bitmap mask sequence on each interface or the bitmap mask sequence covering the same range can be different for different interfaces if desired. In another example, a plurality of bitmapped address ranges can be associated with a single interface. In traditional routing not using bitmap network masks, a locally attached network is associated with a netmask requiring a larger number of bits to match than a remote network. A router picks the route with the most number of bits matching as the best route. In a bitmap forwarding table, a directly connected indicator can be included for each directly connected bitmap network mask.

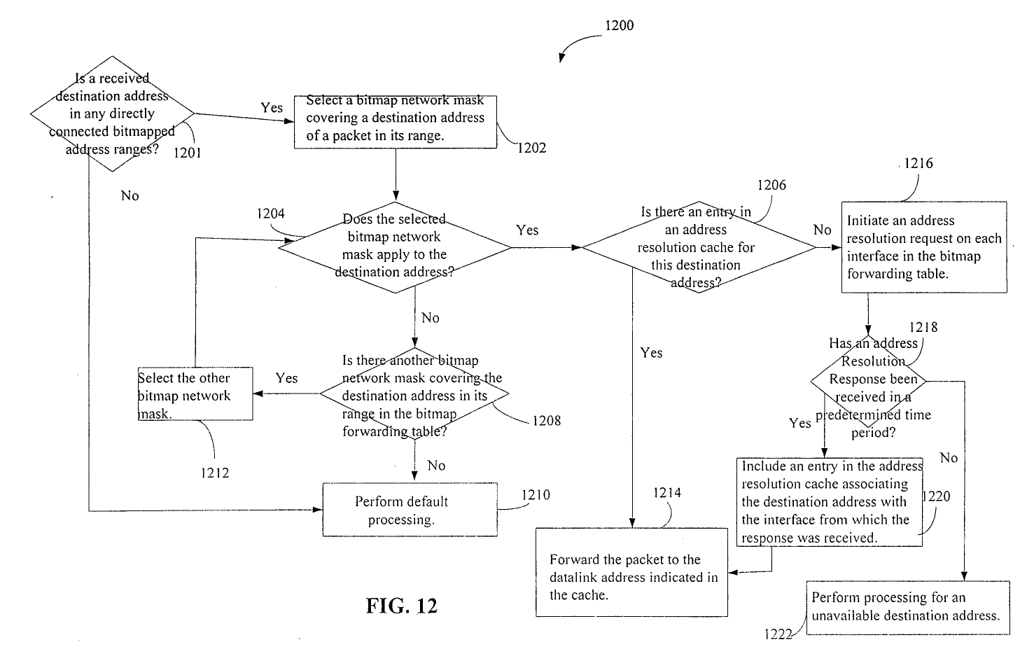

FIG. 12 is a flow chart diagram of a method 1200 for making a forwarding decision for a data packet using a bitmap network mask in accordance with an embodiment of the present invention. For illustrative purposes only and not to be limiting thereof, the method embodiment 1200 of FIG. 12 is discussed in the context of the system embodiment 1000 of FIG. 10. The router 1002 determines 1201 using the bitmap network mask check module 208 whether a received destination address is in any directly connected bitmapped address ranges. Responsive to a negative determination, the router 1002 performs 1210 default processing. An example of default processing is sending the destination address to another standard (non-bitmap) forwarding table for lookup or routing the packet via a default route for packets that don't match any other route. Responsive to a positive determination, the router 1002 selects 1202 a bitmap network mask covering a destination address of a packet in its range. For example, the router 1002 can select a bitmap network mask covering an address range indicated to be directly connected and can send a request to the bitmap network mask check module 208 which in turn determines 1204 whether the selected bitmap network mask applies to the destination address. Responsive to a negative determination, the router 1002 using the bitmap network mask check module 208 determines 1208 whether there is another bitmap network mask covering the destination address in its range in the bitmap forwarding table. Responsive to a negative determination, the router 1002 performs 1210 default processing. Responsive to a determination (1208) that there is another bitmap network mask covering the destination address in the table, the router 1002 selects 1212 another bitmap network mask. The bitmap network mask check module 208 determines 1204 whether the selected bitmap network mask applies to the destination address. Responsive to a positive determination, the router 1002 determines 1206 whether there is an entry in an address resolution cache for this destination address. Responsive to there being an entry in the cache, the router 1002 forwards 1214 the packet to the data link address indicated in the cache. Responsive to there not being an entry in the cache for the destination address, the router 1002 initiates 1216 an address resolution request on each interface in the bitmap forwarding table. Responsive to not receiving (1218) an address resolution response in a predetermined time period (e.g. timeout period), the router 1002 performs 1222 processing for an unavailable destination address. For example, the router 1002 can send a message to the source address indicating the destination address is unavailable. Responsive to receiving (1218) an address resolution response in the predetermined time period, the router 1002 includes 1220 an entry in the address resolution cache associating the destination address with the interface from which the response was received, and forwards 1214 the packet to the data link address indicated in the cache.

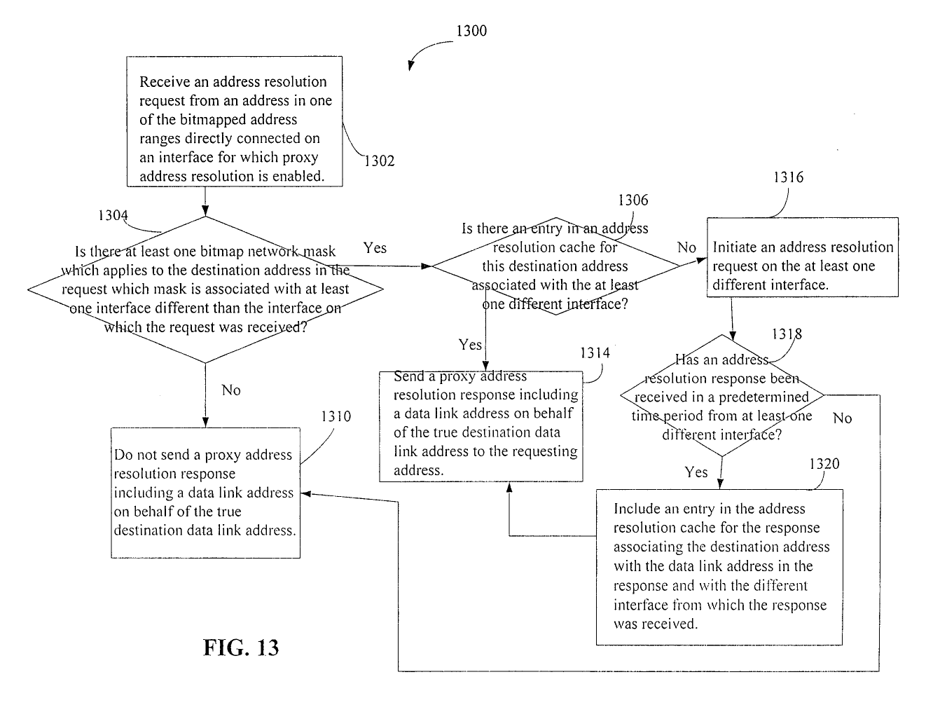

FIG. 13 is a flow chart diagram of a method 1300 for performing proxy address resolution using a bitmap network mask responsive to a request received from a directly connected address in accordance with an embodiment of the present invention. For illustrative purposes only and not to be limiting thereof, the method embodiment 1200 of FIG. 12 is discussed in the context of the system embodiment 1000 of FIG. 10. In standard technology, proxy address resolution is not done for a directly connected address range. However, if a bitmap network address range is directly connected to more than one interface, proxy address resolution can be performed. The router 1002 receives 1302 an address resolution request from an address in one of the bitmapped address ranges directly connected on an interface for which proxy address resolution is enabled. Using the bitmap network mask check module 208, the router 1002 determines 1304 whether there is at least one bitmap network mask which applies to the destination address in the request which mask is associated with at least one interface different than the interface on which the request was received. Responsive to a negative determination, the router 1002 does not send 1310 a proxy address resolution response including a data link address of the router 1002 on behalf of (i.e., proxy) of the true destination data link address. Responsive to a positive determination, the router 1002 determines 1306 whether there is an entry in an address resolution cache for this destination address associated with the at least one different interface. Responsive to there being such an entry in the cache, the router 1002 sends 1314 a proxy address resolution response including a data link address of the router 1002 on behalf of the true destination data link address to the requesting address. Responsive to there not being such an entry in the cache for this destination address, the router 1002 initiates 1316 an address resolution request on the at least one different interface. Responsive to not receiving (1318) an address resolution response in a predetermined time period (e.g. timeout period), the router 1002 does not send 1310 a proxy address resolution response including a data link address of the router 1002 on behalf of the true destination data link address. Responsive to receiving an address resolution response in the predetermined time period, the router 1002 includes 1320 an entry in the address resolution cache for the response associating the destination address with the data link address in the response and with the different interface from which the response was received, and sends 1314 a proxy address resolution response including a data link address of the router 1002 on behalf of the true destination data link address to the requesting address.

A bitmap network mask can include more than one bit per entry. For example, a nibble or a byte or other number of bits can be used to represent more information than that represented by one bit. For example, a port number (e.g. 1-256 in 8 bits) of a device can be stored in a bit map entry, or a ranking (e.g., 0-7 in 3 bits).

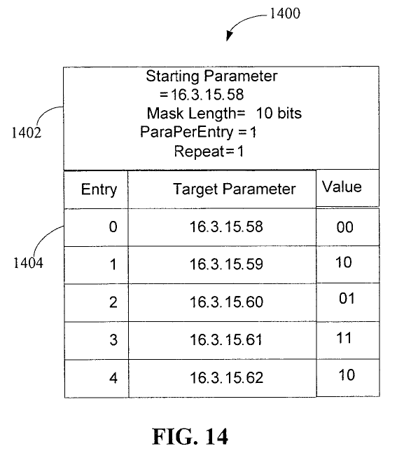

FIG. 14 is an example of a bitmask network mask 1400 including more than one bit per entry in accordance with another embodiment of the present invention. FIG. 14 illustrates a bitmap network mask 1400 having a mask sequence 1404 and having as indexing parameters 1402 a starting parameter, which in this example is an address, a mask length in terms of a number of entries multiplied by entry size, in this example 10 bits, a number of parameters per entry denoted as a field labeled “ParaPerEntry,” and a number of times the mask is repeated as indicated by a “Repeat” field. As the values of ParaPerEntry and Repeat are one (1), the mask sequence 1404 has one entry corresponding to each parameter in the range of five (5) parameters covered by the bitmap network mask 1400 starting with the starting parameter, in this example an address 16.3.15.58. Furthermore, in this example, the entry size is two bits, and values of each entry are shown as two bit values. For example, the entry for address 16.3.15.58 is “00” while the entries for 16.3.15.59 and 16.3.15.62 are both “10” in binary. The bits in an entry can also be subdivided to provide different fields of information. For example, an entry can have four fields of two bits in which each two bit segment can represent one of four states or values, thus the entry represents a combination of four of 16 possible states or values.

Being able to represent more information can be useful in a variety of contexts. One example of such a context is tracking timeouts of forwarding table entries. Below is one example of using two versions of bitmap forwarding tables for tracking timeouts of entries wherein each bitmap network mask only has one bit per address. An operator sets a timeout interval, at the end of which a next bitmap forwarding table replaces a current bitmap forwarding table. In the illustrative embodiment of FIG. 10, the router 1002 uses the current bitmap forwarding table for the interval between timeouts, but updates the current and next bitmap forwarding tables accordingly for source addresses and destinations that respond to address resolution requests. For entries that were not active in the “timeout” interval, the router 1002 drops them from the next bitmap forwarding table unless they are designated static entries that cannot be dropped. When the timeout period ends, the next bitmap forwarding table becomes the current bitmap forwarding table.

However, a bitmap network mask with multiple bits per entry can be used for tracking timeouts as well. For example, a bitmap network mask can include 2 bits per entry. This implementation has the same space requirement as using two bit maps, but can provide more flexibility. The two bits for each entry can be used to represent four states. For example:
00—“OFF” This entry is not included in the mask.
10—“CURRENT” This entry is included in the mask, and has had recent activity.
01—“AGED” This entry is included in the mask, but has NOT had recent activity.
11—“PERSISTENT” This entry is included in the mask and doesn't age.
   The OR function on the two bits can determine whether the mask applies. If (bit1 OR bit2) is 1 then the mask applies, if 0 then the mask doesn't apply. From state “OFF”, the state can be changed to “CURRENT” if an instruction is received to include the entry in the mask. From state “CURRENT”, the state changes to “AGED” at each timeout interval. From state “AGED”, the state changes to “OFF” at each timeout interval. The aging function can be applied to every entry in the map at each aging interval. For example, if (bit1 XOR bit2) is 1 then subtract 1 from the entry value to set it to “OFF.” From state “AGED”, the state changes to “CURRENT” if there is activity. An “add 1” operation can be used to make this state change. From any state, the state can be changed to “PERSISTENT” if an instruction is received to statically add the entry in the mask. Also, from any state, the state can be changed to “OFF” if an instruction is received to remove the entry from the mask. In another example, the state can be changed to CURRENT from any other state upon explicit instruction.

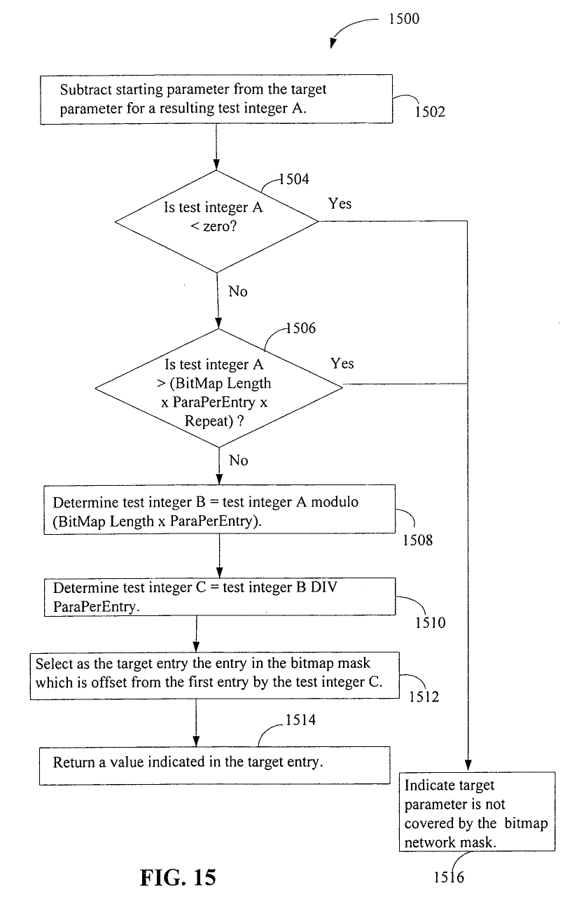

FIG. 15 is a flow chart diagram of a method 1500 for locating an entry within a bitmap network mask with multiple bits per entry for a network parameter in accordance with another embodiment of the present invention. For illustrative purposes only and not to be limiting thereof, the method embodiment 1500 of FIG. 15 is discussed in the context of the system embodiment 200 of FIG. 2. The bitmap network mask check module 208 subtracts 1502 a starting parameter of the mask from the target parameter for a resulting test integer A and determines 1504 whether the test integer A is less than zero. Responsive to the test integer A being less than zero, the check module 208 indicates 1516 the target parameter is not covered by the bitmap network mask. Responsive to the test integer A not being less than zero, the check module 208 determines 1506 whether the test integer A is greater than the product of the BitMap Length multiplied by the number of parameters per entry, ParaPerEntry, multiplied by the number of times the mask is repeated, Repeat. The BitMap Length is the length of the bitmap mask sequence in terms of the number of entries multiplied by the entry size. Responsive to the test integer A being greater than the product, the check module 208 indicates 1516 the target parameter is not covered by the bitmap network mask. Responsive to the test integer A not being greater than the product, the check module 208 determines 1508 test integer B as the result from test integer A modulo the product of the BitMap Length multiplied by the number of parameters per entry, ParaPerEntry. Additionally, the check module 208 determines 1510 test integer C as the quotient of test integer B divided by the number of parameters per entry, ParaPerEntry, and selects 1512 as the target entry the entry in the bitmap mask which is offset from the first entry by the test integer C. The check module 208 returns 1514 a value indicated in the target entry.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the hereto appended claims. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A method for processing network parameters in accordance with a bitmap network mask comprising:
determining whether the bitmap network mask applies to a network parameter; and
processing the network parameter based on a result for the determination.

2. A method for determining whether a bitmap network mask including a mask sequence of entries in which each entry corresponds to a network parameter in a range of parameters covered by the bitmap network mask and a respective value of each entry represents whether the mask applies to the corresponding parameter, and one or more indexing parameters for locating an entry in the mask sequence applies to a network parameter comprising:
determining the target entry in a bitmap mask sequence corresponding to a target parameter based on the one or more indexing parameters; and
determining whether the bitmap network mask applies based on a value in the target entry.

3. The method of claim 2 further comprising creating a bitmap network mask comprising:
receiving one or more network parameters for which the bitmap network mask is to apply;
determining one or more indexing parameters for the bitmap network mask;
determining a number of entries for the mask sequence of entries based on the one or more indexing parameters; and
setting entries in the mask sequence to indicate to which network parameters the bitmap network mask applies.

4. The method of claim 2 wherein the one or more indexing parameters comprise:
a starting network parameter and a bitmap length representing a range of network parameters covered by the bitmap network mask.

5. The method of claim 4 wherein an entry size of entries in a bitmap network mask is one bit and wherein determining whether the bitmap network mask applies to a network parameter further comprises:
subtracting the starting parameter from a target parameter for a resulting test integer;
responsive to the resulting test integer being less than zero, returning a negative result for the determination;
responsive to the resulting test integer not being less than zero, determining whether the resulting test integer is greater than the bit map length;
responsive to the resulting test integer being greater than the bit map length, returning an indicator that the bitmap network mask does not apply;
responsive to the resulting test integer not being greater than the bit map length, determining a target bit corresponding to the target address as an offset bit in the bitmap mask which is offset from the first bit in the bitmap by the resulting test integer;
checking the value of the target bit;
responsive to the target bit value indicating that the bitmap network mask does not apply, returning an indicator that the bitmap network mask does not apply; and
responsive to the target bit value indicating that the bitmap network mask does apply, returning an indicator that the bitmap network mask does apply.

6. The method of claim 4 wherein the indexing parameters of the bitmap network mask further comprise:
a number of parameters associated with each entry.

7. The method of claim 4 wherein the indexing parameters of the bitmap network mask further comprise:
a number of times the mask is repeated.

8. The method of claim 7 wherein an entry size of entries in the mask sequence is one bit and wherein the indexing parameters of the bitmap network mask further comprise a number of parameters associated with each bit and determining whether the bitmap network mask applies to a network parameter further comprises:
subtracting the starting parameter from a target parameter for a first resulting test integer;
responsive to the first resulting test integer being less than zero, returning an indicator that the bitmap network mask does not apply;
responsive to the first resulting test integer not being less than zero, determining whether the first resulting test integer is greater than the product of the bit map length, the number of parameters associated with each bit, and the number of times the mask is repeated;
responsive to the first resulting test integer being greater than the product of a bit map length, a number of parameters associated with each bit, and a number of times the mask is repeated, returning an indicator that the bitmap network mask does not apply;
responsive to the first resulting test integer not being greater than the product of the bit map length, the number of parameters associated with each bit, and the number of times the mask is repeated,
determining a second resulting test integer from the first resulting test integer modulo the product of the bit map length and the number of parameters associated with each bit;
determining a third resulting test integer from the quotient of the second resulting test integer divided by the number of parameters associated with each bit;
selecting as a target bit an offset bit in the bitmap mask which is offset from the first bit by the third resulting test integer;
responsive to the target bit indicating that the bitmap network mask does not apply, returning an indicator that the bitmap network mask does not apply; and
responsive to the target bit indicating that the bitmap network mask does apply, returning an indicator that the bitmap network mask does apply.

9. The method of claim 1 wherein processing the network parameter based on a result for the determination further comprises:
determining whether an access control list applies to the network parameter.

10. The method of claim 1 wherein processing the network parameter based on a result for the determination further comprises:
determining whether a policy applies to the network parameter.

11. The method of claim 1 wherein processing the network parameter based on a result for the determination further comprises:
permitting transfer of data using a network communication protocol based on the result for the determination.

12. The method of claim 1 wherein processing the network parameter based on a result for the determination further comprises:
permitting transfer of data through a port based on the result for the determination.

13. The method of claim 1 wherein processing the network parameter based on a result for the determination further comprises:
determining a forwarding path for a network data packet based on the network parameter.

14. The method of claim 1 wherein processing the network parameter based on a result for the determination further comprises:
controlling dynamic access for a computer associated with the network parameter.

15. The method of claim 1 wherein processing the network parameter based on a result for the determination further comprises:
processing a proxy address resolution request from an address in at least one bitmapped address range directly connected on an interface.

16. The method of claim 1 wherein processing the network parameter based on a result for the determination further comprises:
tracking age of entries in a forwarding table including at least one bitmap network mask representing a range of addresses associated with a network interface.

17. The method of claim 1 further comprising:
receiving a request for a change in status for at least one network parameter covered by a bitmap mask; and
updating an entry corresponding to the at least one network parameter in the bitmap mask sequence to effect the requested change.

18. The method of claim 2 further comprising:
updating the bitmap network mask by overlaying a bitmap update to at least a portion of the bitmap network mask sequence.

19. The method of claim 18 wherein updating the bitmap network mask by overlaying a bitmap update to at least a portion of the bitmap network mask sequence further comprises:
performing an operation for bits of the bitmap network mask effected by the bitmap update based on an indicator.

20. The method of claim 19 wherein the indicator indicates a replace operation in which the value of each bit in the bitmap update replaces the value for the corresponding bit in the bitmap network mask sequence.

21. The method of claim 19 wherein the indicator indicates an OR operation in which for each bit in the bitmap update of a certain value, the corresponding bit in the bitmap mask is updated to the certain value.

22. The method of claim 19 wherein the indicator indicates an Not OR operation in which for each bit in the bitmap update of a certain value, the corresponding bit in the bitmap mask is updated to a value other than the certain value.

23. The method of claim 19 wherein the indicator indicates an XOR operation in which for each bit in the bitmap update of a certain value, the value of the corresponding bit in the bitmap mask is toggled.

24. A bitmap network mask for use in a method for processing network parameters comprising:
a mask sequence of entries in which each entry corresponds to a network parameter in a range of parameters covered by the bitmap network mask and a respective value in each entry represents whether the mask applies to the corresponding parameter, and
one or more indexing parameters for locating an entry in the mask sequence corresponding to a network parameter.

25. The bitmap network mask of claim 24 wherein the one or more indexing parameters include:
a starting network parameter from which a target network parameter can be differenced; and
a bitmap length representing a number of network parameters in a range of network parameters covered by the bitmap network mask.

26. The bitmap network mask of claim 25 where the one or more indexing parameters further include:
a number of times the mask is repeated.

27. The bitmap network mask of claim 25 where the one or more indexing parameters further include:
a number of parameters associated with each entry.

28. A system for determining whether a bitmap network mask applies to a network parameter comprising:
a bitmap network address mask storage module for storing one or more bitmap network masks wherein each bitmap network mask includes
a mask sequence of entries in which each entry corresponds to a network parameter in a range of parameters covered by the bitmap network mask and a respective value in each entry represents whether the mask applies to the corresponding parameter, and
one or more indexing parameters for locating an entry in the mask sequence corresponding to a network parameter;
a bitmap network mask definition module having access to the bitmap network address mask storage module, the bitmap network mask definition module defining the mask sequence of entries for the bitmap network mask based upon network parameters in received user input and one or more indexing parameters; and
a bitmap network mask check module also having access to the bitmap network address mask storage module and being communicatively coupled to the bitmap network mask definition module, the bitmap network mask check module determining whether the bitmap network mask applies to a network parameter.

29. The system of claim 28 wherein the bitmap network mask definition module updates at least one entry corresponding to at least one network parameter in the bitmap mask sequence responsive to a request for a change in status for the at least one network parameter covered by a bitmap network mask.

30. A computer usable medium comprising instructions for causing a processor to execute a method for determining whether a bitmap network mask including a mask sequence of entries in which each entry corresponds to a network parameter in a range of parameters covered by the bitmap network mask and a respective value in each entry represents whether the mask applies to the corresponding parameter, and one or more indexing parameters for locating an entry in the mask sequence applies to a network parameter, the method comprising:
determining the target entry in a bitmap mask sequence corresponding to a target parameter based on the one or more indexing parameters; and
determining whether the bitmap network mask applies based on a value in the target entry.

31. A system for processing network parameters in accordance with a bitmap network mask comprising:
means for determining whether the bitmap network mask applies to a network parameter.
